(19) United States
(12) Patent Application Publication
(10) Pub. No.: US 2025/0381810 A1
(43) Pub. Date: Dec. 18, 2025

(54) VEHICLE TRACTOR

(71) Applicant: Shenzhen Yatu Trading Co., Ltd., Shenzhen (CN)

(72) Inventor: Hongli WEI, Meishan (CN)

(73) Assignee: Shenzhen Yatu Trading Co., Ltd., Shenzhen (CN)

(21) Appl. No.: 18/746,879

(22) Filed: Jun. 18, 2024

(51) Int. Cl. B60D 1/07; B60D 1/32; B60D 1/46

(52) U.S. Cl. CPC B60D 1/07; B60D 1/32; B60D 1/46

(57) ABSTRACT

The present invention relates to the field of tractors, and discloses a vehicle tractor. The vehicle tractor includes a traction front arm which is inserted and mounted in a trailer inserting end, and a traction rear arm which is mounted at a vehicle head connecting end. Through an arranged insertion prompting mechanism, under the action of damping telescopic rods and a connecting spring, a turning-over plate is abutted against the vehicle head connecting end, whereby a limiting effect is achieved, and the vehicle head connecting end is prevented from sliding; and on the other hand, when the turning-over plate turns over, the meshing gear on a front side of the turning-over plate moves upwards to be meshed with the transmission gear, at this time, the transmission gear rotates clockwise, connecting arms connected to the transmission gear through transmission shafts rotate clockwise along with the transmission gear.

### TECHNICAL FIELD

The present invention relates to the field of tractors, and in particular to a vehicle tractor.

### BACKGROUND

With increase in the number of cars, vehicle breakdowns and situations needing rescue are becoming increasingly common. Therefore, the demand for a vehicle tractor, as a common rescue tool, has also increased accordingly. In emergency situations such as natural disasters and traffic accidents, it is very important to move vehicles quickly and effectively. As an important rescue tool, the tractor can quickly drag trapped vehicles out of trapped positions. In addition to rescue services, the vehicle tractor is also widely used in vehicle transportation, car repairs, airport services, construction sites, and other occasions, for moving vehicles or carrying out maintenance operations.

According to the Chinese authorized patent with Publication No. CN214355390U, the disclosed vehicle tractor includes a traction head, a rope pillar, a hook bottom plate, a connecting shaft, and a lock for driving the connecting shaft to move along its axial direction, where the rope pillar extends into the traction head and is connected to the traction head; the hook bottom plate is in sliding connection to the traction head; at least two grooves in mutual communication are formed in the hook bottom plate; one end of the connecting shaft penetrates into the traction head and penetrates through the rope pillar, and the other end of the connecting shaft cooperates with the grooves; and one end of the lock extends into the traction head to be connected to the connecting shaft. The utility model can well achieve up-down adjustment of the tractor, whereby a pull rope is parallel to the ground as much as possible in a vertical plane, and the power of one vehicle is efficiently utilized to draw another vehicle to move. However, there are still shortcomings in the vehicle tractor. In a mounting and connection process between the vehicle tractor and the vehicle, it is difficult for a user to determine whether a vehicle head connecting end has been completely inserted into a traction rear arm solely by visual observation, which may lead to insufficient insertion of a vehicle connecting end. During subsequent insertion of pin shafts, the user needs to adjust an insertion position multiple times, which is more troublesome.

### SUMMARY

To overcome shortcomings in the prior art, the present invention provides a vehicle tractor to solve the problem that in a mounting and connection process between the vehicle tractor and a vehicle, it is difficult for a user to determine whether a vehicle head connecting end has been completely inserted into a traction rear arm solely by visual observation, which may lead to insufficient insertion of a vehicle connecting end. During subsequent insertion of pin shafts, the user needs to adjust an insertion position multiple times, which is more troublesome.

In order to achieve the purpose mentioned above, the present invention adopts the following technical solution: the vehicle tractor includes:
a traction front arm which is inserted and mounted in a trailer inserting end;
a traction rear arm which is mounted at a vehicle head connecting end;
an interface switching mechanism which is mounted on a rear side of the traction rear arm; and
an insertion prompting mechanism which is arranged on an upper surface of the traction rear arm.

Preferably, the interface switching mechanism is arranged behind the traction rear arm, the interface switching mechanism includes a storage box, a separating box, pin shafts, nuts and a box cover, where the storage box is embedded in the traction rear arm, and the box cover is fixedly connected to a rear side of the storage box.

Preferably, the separating box is fixedly connected to a front side of the storage box, a plurality of nuts are arranged in the separating box, and a plurality of pin shafts are arranged between the separating box and the storage box.

Preferably, a rear end of the traction front arm is fixedly connected to a front side of an upright column, a concave gasket is in snap-fit connection to a rear side of the upright column, the traction rear arm is fixedly connected to a rear side of the concave gasket, and an insertion prompting mechanism is arranged on an upper surface of the traction front arm; and the insertion prompting mechanism includes a turning-over plate, connecting slide rails, L-shaped support arms, damping telescopic rods, a transmission gear, a meshing gear and an arc-shaped slideway, where the turning-over plate is embedded on an upper surface of the traction rear arm, a rear end of the turning-over plate is rotatably connected to the traction front arm, the connecting slide rails are fixedly connected to left and right sides of an upper surface of the turning-over plate, slide blocks are in sliding connection to upper surfaces of the two connecting slide rails, support pads are fixedly connected to upper surfaces of the two slide blocks, the damping telescopic rods are arranged on upper surfaces of the support pads, free ends of the damping telescopic rods are in rotatable connection to the support pads, fixed ends of the damping telescopic rods are fixedly connected to lower surfaces of the L-shaped support arms, and one ends, away from the damping telescopic rods, of the L-shaped support arms are fixedly connected to the upper surface of the traction rear arm.

Preferably, the transmission gear is embedded at a middle of a front side of the turning-over plate, the transmission gear is fixedly connected to the turning-over plate, the meshing gear is arranged above a front side of the transmission gear, the meshing gear is embedded on an upper surface of the traction rear arm, the meshing gear is rotatably connected to the traction rear arm, transmission shafts are fixedly connected to left and right sides of the meshing gear, connecting arms are fixedly connected to one ends, away from the meshing gear, of the two transmission shafts, lower ends of the connecting arms are embedded in the arc-shaped slideway, the arc-shaped slideway is fixedly connected to an outer side of the traction rear arm, and a prompting column is fixedly connected to a position above a rear side of the traction rear arm.

Preferably, the transmission shafts penetrate through a positioning plate, a lower end of the positioning plate is fixedly connected to an upper surface of the traction rear arm, a reset torsion spring is arranged on an outer side of the positioning plate, and the reset torsion spring is sleeved outside the transmission shafts.

Preferably, a triangular reinforcement plate is fixedly connected to a connecting position of the traction front arm and the upright column.

Preferably, a plurality of front arm pin holes are symmetrically formed in left and right sides of the traction front arm, a plurality of rear arm pin holes are symmetrically formed in two sides of the traction rear arm, a traction ball is fixedly connected to an upper surface of the traction rear arm, and a hook is fixedly connected to a lower surface of the traction rear arm.

Preferably, a plurality of upright column pin holes are symmetrically formed in two sides of the upright column, and a plurality of gasket pin holes are symmetrically formed in two sides of the concave gasket.

Preferably, a connecting spring is sleeved outside the damping telescopic rod.

### BENEFICIAL EFFECTS

The present invention provides the vehicle tractor. Compared with the prior art, the vehicle tractor has the following benefits:
1. the insertion prompting mechanism is arranged, whereby in a process that the vehicle tractor is in a traction connection to a vehicle, a user can pull the interface switching mechanism out of the traction rear arm, at this time, the rear end of the traction rear arm can be connected to an interface of a vehicle head, in a process that the vehicle head connecting end is inserted into the traction rear arm, as a traction connecting end continuously enters a front side of the traction rear arm, the traction connecting end may extrude the turning-over plate when moving forwards, and the turning-over plate turns over to a level state from a diagonal state; on one hand, in a process that the turning-over plate turns over, the slide blocks located on the upper surface of the turning-over plate slide and upwards extrude the damping telescopic rods and the connecting spring, under the action of the damping telescopic rods and the connecting spring, the turning-over plate is abutted against the vehicle head connecting end, whereby a limiting effect is achieved, and the vehicle head connecting end is prevented from sliding; and on the other hand, when the turning-over plate turns over, the meshing gear on a front side of the turning-over plate moves upwards to be meshed with the transmission gear, at this time, the transmission gear rotates clockwise, connecting arms connected to the transmission gear through transmission shafts rotate clockwise along with the transmission gear, and lower ends of the connecting arms slide in the traction rear arm until the lower ends of the connecting arms slide to positions being level to a prompting column, indicating that the vehicle head connecting end is completely inserted into the traction rear arm. The user can judge whether the vehicle head connecting end is completely inserted into the traction rear arm by observing positions of the connecting arms and the prompting column, and in this manner, effects of limiting and observing whether the vehicle head connecting end is completely inserted into the traction rear arm can be achieved at the same time in a process that the vehicle head connecting end is inserted into the traction rear arm.
2. In the vehicle tractor disclosed by the present invention, the interface switching mechanism is arranged, whereby when the vehicle tractor is not used, the pin shafts and the nuts, which need to be used for traction connection with a vehicle, are placed in the storage box and the separating box respectively, and in a subsequent process of traction connection to the vehicle, the pin shafts and the nuts can be taken out as long as the storage box is pulled out of the traction rear arm, without spending time in searching or taking out the pin shafts and the nuts from a tool kit. Compared with a traditional tractor which is made by direct connection of the traction front arm and the traction rear arm, the vehicle tractor disclosed by the invention has effects of extending and lengthening, whereby connection efficiency is greatly improved, and besides, quick connection can be performed quickly when the vehicle tractor is urgently used. In addition, after the storage box is pulled out, the traction rear arm, as an interface, can be mutually connected to the vehicle head connecting end; and besides, the interface adopting an industrial standard component is convenient to replace and use, which is convenient.

### BRIEF DESCRIPTION OF DRAWINGS

FIG. 1 shows a schematic structural diagram of a vehicle tractor provided by the present invention, after an insertion prompting mechanism is removed;

FIG. 2 shows a schematic diagram of a perspective structure of a rear side of a vehicle tractor provided by the present invention;

FIG. 3 shows a schematic diagram of a perspective structure of a front side of a vehicle tractor provided by the present invention;

FIG. 4 shows a schematic structural diagram of a vehicle tractor provided by the present invention, after an interface switching mechanism is pulled out;

FIG. 5 shows a schematic structural diagram of a vehicle tractor provided by the present invention, after an interface switching mechanism is pulled out, in an inclined down view;

FIG. 6 shows a schematic structural diagram of a traction rear arm of a vehicle tractor provided by the present invention; and

FIG. 7 shows an enlargement view of a part A shown in FIG. 6 of a vehicle tractor provided by the present invention.

### DESCRIPTION OF FIGURES

1—traction front arm; 2—traction rear arm; 3—upright column; 4—concave gasket; 5—traction ball; 6—hook; 7—interface switching mechanism; 701—storage box; 702—separating box; 703—pin shaft; 704—nut; 705—box cover; 8—insertion prompting mechanism; 801—turning-over plate; 802—connecting slide rail; 803—L-shaped support arm; 804—damping telescopic rod; 805—connecting spring; 806—slide block; 807—transmission gear; 808—meshing gear; 809—transmission shaft; 810—positioning plate; 811—reset torsion spring; 812—connecting arm; 813—arc-shaped slideway; 814—prompting column; 815—support pad; 9—front arm pin hole; 10—upright column pin hole; 11—rear arm pin hole; 12—gasket pin hole; 13—triangular reinforcement plate.

### DETAILED DESCRIPTION OF THE EMBODIMENTS

The technical solution of the present invention will be clearly and completely described in the following with reference to the accompanying drawings. It is obvious that the embodiments to be described are only a part rather than all of the embodiments of the present invention. All other embodiments obtained by persons of ordinary skill in the art based on the embodiments of the present invention without creative efforts shall fall within the protection scope of the present invention.

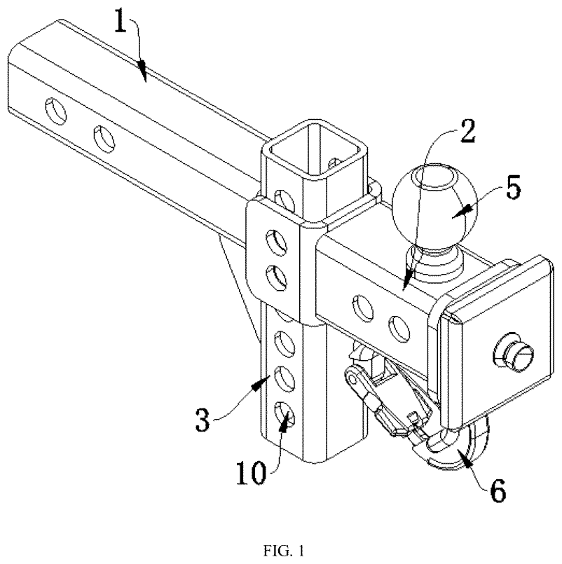

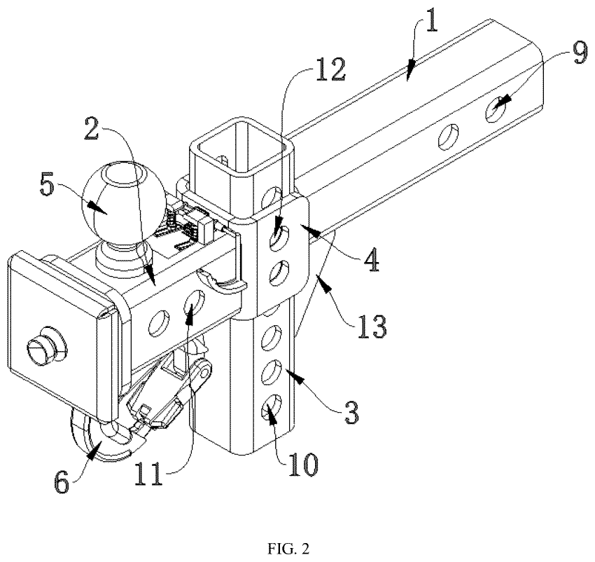

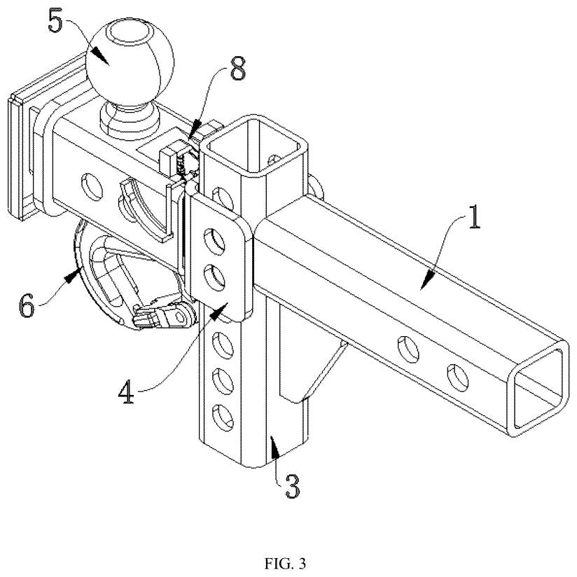

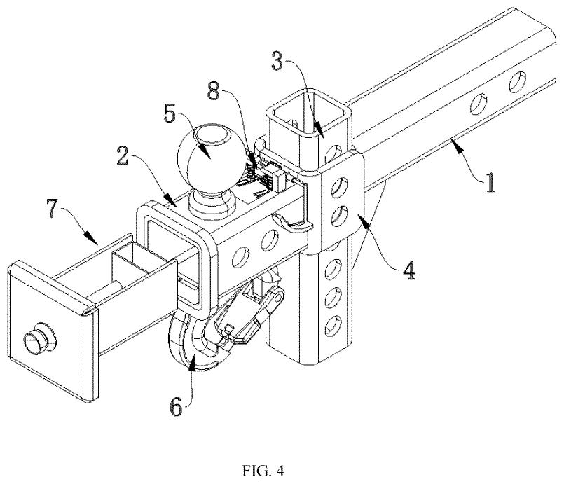

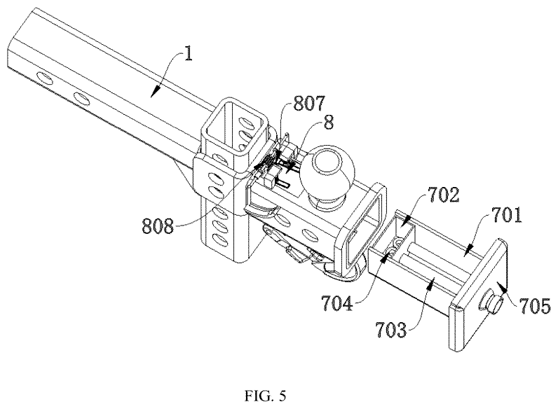

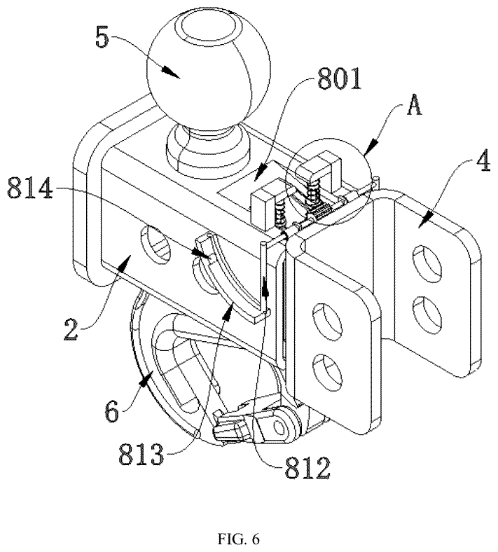

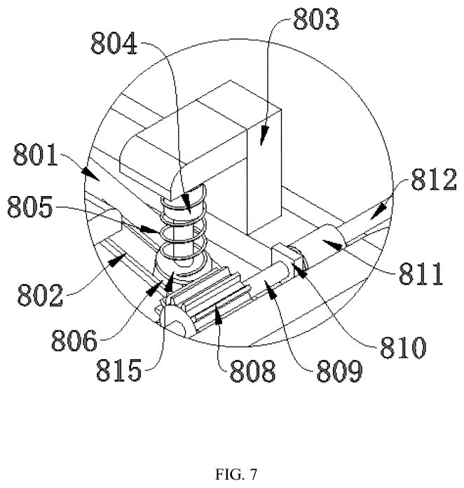

Referring to FIG. 1-FIG. 7, the present invention provides two technical solutions, specifically including the following embodiments:

### Embodiment I

A vehicle tractor includes;
a traction front arm 1 which is inserted and mounted in a trailer inserting end;
a traction rear arm 2 which is mounted at a vehicle head connecting end;
an interface switching mechanism 7 which is mounted on a rear side of the traction rear arm 2; and
an insertion prompting mechanism 8 which is arranged on an upper surface of the traction rear arm 2.

The interface switching mechanism 7 is arranged behind the traction rear arm 2, the interface switching mechanism 7 includes a storage box 701, a separating box 702, pin shafts 703, nuts 704 and a box cover 705, where the storage box 701 is embedded in the traction rear arm 2, the box cover 705 is fixedly connected to a rear side of the storage box 701, the separating box 702 is fixedly connected to a front side of the storage box 701, a plurality of nuts 704 are arranged in the separating box 702, a plurality of pin shafts 703 are arranged between the separating box 702 and the storage box 701, a triangular reinforcement plate 13 is fixedly connected to a connecting position of the traction front arm 1 and an upright column 3, and a vertical surface is arranged on a front side of the triangular reinforcement plate 13; and a plurality of front arm pin holes 9 are symmetrically formed in left and right sides of the traction front arm 1, a plurality of rear arm pin holes 11 are symmetrically formed in two sides of the traction rear arm 2, a plurality of upright column pin holes 10 are symmetrically formed in two sides of the upright column 3, a plurality of gasket pin holes 12 are symmetrically formed in two sides of a concave gasket 4, a traction ball 5 is fixedly connected to an upper surface of the traction rear arm 2, and a hook 6 is fixedly connected to a lower surface of the traction rear arm 2. When the vehicle tractor is mounted, the pin shafts 703 and the nuts 704 are taken out, the traction front arm 1 is inserted into a trailer inserting end, the pin shafts 703 are inserted into pin holes of the front arm pin shaft 703 and the trailer inserting end, the nuts 704 are screwed down, then the vehicle head connecting end of a vehicle requiring traction is inserted into the traction rear arm 2, the pin shafts 703 are inserted into the rear arm pin holes 11 of the traction rear arm 2 and pin holes of the vehicle head connecting end in the same manner, then the nuts 704 are screwed down, the concave gasket 4 and the upright column 3 are connected in this manner, and mounting of the vehicle tractor can be completed.

When the vehicle tractor is not used, the pin shafts 703 and the nuts 704, which need to be used for traction connection with the vehicle, are placed in the storage box 701 and the separating box 702 respectively, and in a subsequent process of traction connection to the vehicle, the pin shafts 703 and the nuts 704 can be taken out as long as the storage box 701 is pulled out of the traction rear arm 2, without spending time in searching or taking out the pin shafts and the nuts from a tool kit, whereby connection efficiency is greatly improved, and besides, quick connection can be performed quickly when the vehicle tractor is urgently used. In addition, after the storage box 701 is pulled out, the traction rear arm 2, as an interface, can be mutually connected to the vehicle head connecting end, which is convenient.

### Embodiment II

Based on Embodiment I, a rear end of a traction front arm 1 is fixedly connected to a front side of an upright column 3, a concave gasket 4 is in snap-fit connection to a rear side of the upright column 3, a traction rear arm 2 is fixedly connected to a rear side of the concave gasket 4, and an insertion prompting mechanism 8 is arranged on an upper surface of the traction front arm 1; the insertion prompting mechanism 8 includes a turning-over plate 801, connecting slide rails 802, L-shaped support arms 803, damping telescopic rods 804, a transmission gear 807, a meshing gear 808 and an arc-shaped slideway 813, where the turning-over plate 801 is embedded on an upper surface of the traction rear arm 2, a rear end of the turning-over plate 801 is rotatably connected to the traction front arm 1, the connecting slide rails 802 are fixedly connected to left and right sides of an upper surface of the turning-over plate 801, slide blocks 806 are in sliding connection to upper surfaces of the two connecting slide rails 802, support pads 815 are fixedly connected to upper surfaces of the two slide blocks 806, the damping telescopic rods 804 are arranged on upper surfaces of the support pads 815, free ends of the damping telescopic rods 804 are in rotatable connection to the support pads 815, fixed ends of the damping telescopic rods 804 are fixedly connected to lower surfaces of the L-shaped support arms 803, and one ends, away from the damping telescopic rods 804, of the L-shaped support arms 803 are fixedly connected to the upper surface of the traction rear arm 2. The transmission gear 807 is embedded at the middle of a front side of the turning-over plate 801, the transmission gear 807 is fixedly connected to the turning-over plate 801, the meshing gear 808 is arranged above a front side of the transmission gear 807, the meshing gear 808 is embedded on an upper surface of the traction rear arm 2, the meshing gear 808 is rotatably connected to the traction rear arm 2, transmission shafts 809 are fixedly connected to left and right sides of the meshing gear 808, connecting arms 812 are fixedly connected to one ends, away from the meshing gear 808, of the two transmission shafts 809, lower ends of the connecting arms 812 are embedded in the arc-shaped slideway 813, the arc-shaped slideway 813 is fixedly connected to the outer side of the traction rear arm 2, and the prompting column 814 is fixedly connected to a position above the rear side of the traction rear arm 2. The transmission shafts 809 penetrate through a positioning plate 810, a lower end of the positioning plate 810 is fixedly connected to the upper surface of the traction rear arm 2, a reset torsion spring 811 is arranged on an outer side of the positioning plate 810, and the reset torsion spring 811 is sleeved outside the transmission shafts 809. After the vehicle head connecting end is pulled out of the traction rear arm 2, the reset torsion spring 811 reset the transmission gear 807 to an initial position on a front side above the meshing gear 808, and the connecting spring 805 is sleeved outside the damping telescopic rods 804. It should be noted that the connecting spring 805 in the initial state will a but the turning-over plate 801 to the position where a front section is diagonally downward, that is, when the vehicle head connecting end is not inserted into the traction rear arm 2, the front end of the turning-over plate 801 is diagonally downward.

During working, in a process that the vehicle tractor is in a traction connection to a vehicle, a user can pull the interface switching mechanism 7 out of the traction rear arm 2, at this time, the rear end of the traction rear arm 2 can be connected to an interface of a vehicle head, in a process that the vehicle head connecting end is inserted into the traction rear arm 2, as the traction connecting end continuously enters a front side of the traction rear arm 2, the traction connecting end may extrude the turning-over plate 801 when moving forwards, and the turning-over plate 801 turns over to a level state from a diagonal state; on one hand, in a process that the turning-over plate 801 turns over, the slide blocks 806 located on the upper surface of the turning-over plate 801 slide and upwards extrude the damping telescopic rods 804 and the connecting spring 805, under the action of the damping telescopic rods 804 and the connecting spring 805, the turning-over plate 801 is abutted against the vehicle head connecting end, whereby a limiting effect is achieved, and the vehicle head connecting end is prevented from sliding; and on the other hand, when the turning-over plate 801 turns over, the meshing gear 808 on a front side of the turning-over plate 801 moves upwards to be meshed with the transmission gear 807, at this time, the transmission gear 807 rotates clockwise, connecting arms 812 connected to the transmission gear 807 through transmission shafts 809 rotate clockwise along with the transmission gear 807, and lower ends of the connecting arms 812 slide in the traction rear arm 2 until the lower ends of the connecting arms 812 slide to positions being level to the prompting column 814, indicating that the vehicle head connection end is completely inserted into the traction rear arm 2. The user can judge whether the vehicle head connecting end is completely inserted into the traction rear arm 2 by observing positions of the connecting arms 812 and the prompting column 814, and in this manner, effects of limiting and observing whether the vehicle head connecting end is completely inserted into the traction rear arm can be achieved at the same time in a process that the vehicle head connecting end is inserted into the traction rear arm 2.

The above are only the preferred embodiments of the present application, and are not intended to limit the present application. Any modifications, equivalent substitutions and improvements and the like made within the spirit and principles of the present application should fall within the protection scope of the present application.

What is claimed is:

1. A vehicle tractor, comprising:
a traction front arm (1), inserted and mounted in a trailer inserting end, wherein a rear end of the traction front arm (1) is fixedly connected to a front side of an upright column (3), and a concave gasket (4) is in snap-fit connection to a rear side of the upright column (3);
a traction rear arm (2), mounted at a vehicle head connecting end, wherein a rear side of the concave gasket (4) is fixedly connected to the traction rear arm (2); and
an interface switching mechanism (7), mounted on a rear side of the traction rear arm (2), wherein the interface switching mechanism (7) comprises a storage box (701), a separating box (702), pin shafts (703), nuts (704) and a box cover (705).

2. The vehicle tractor according to claim 1, wherein the storage box (701) is embedded in the traction rear arm (2), the box cover (705) is fixedly connected to a rear side of the storage box (701), an insertion prompting mechanism (8) is arranged on an upper surface of the traction front arm (1), and the insertion prompting mechanism (8) comprises a turning-over plate (801), connecting slide rails (802), L-shaped support arms (803), damping telescopic rods (804), a transmission gear (807), a meshing gear (808) and an arc-shaped slideway (813).

3. The vehicle tractor according to claim 2, wherein the separating box (702) is fixedly connected to a front side of the storage box (701), a plurality of nuts (704) are arranged in the separating box (702), and a plurality of pin shafts (703) are arranged between the separating box (702) and the storage box (701).

4. The vehicle tractor according to claim 2, wherein the turning-over plate (801) is embedded on an upper surface of the traction rear arm (2), a rear end of the turning-over plate (801) is rotatably connected to the traction front arm (1), the connecting slide rails (802) are fixedly connected to left and right sides of an upper surface of the turning-over plate (801), slide blocks (806) are in sliding connection to upper surfaces of the two connecting slide rails (802), support pads (815) are fixedly connected to upper surfaces of the two slide blocks (806), the damping telescopic rods (804) are arranged on upper surfaces of the support pads (815), free ends of the damping telescopic rods (804) are in rotatable connection to the support pads (815), fixed ends of the damping telescopic rods (804) are fixedly connected to lower surfaces of the L-shaped support arms (803), and one ends, away from the damping telescopic rods (804), of the L-shaped support arms (803) are fixedly connected to the upper surface of the traction rear arm (2).

5. The vehicle tractor according to claim 4, wherein the transmission gear (807) is embedded at a middle of a front side of the turning-over plate (801), the transmission gear (807) is fixedly connected to the turning-over plate (801), the meshing gear (808) is arranged above a front side of the transmission gear (807), the meshing gear (808) is embedded on an upper surface of the traction rear arm (2), the meshing gear (808) is rotatably connected to the traction rear arm (2), transmission shafts (809) are fixedly connected to left and right sides of the meshing gear (808), connecting arms (812) are fixedly connected to one ends, away from the meshing gear (808), of the two transmission shafts (809), lower ends of the connecting arms (812) are embedded in the arc-shaped slideway (813), the arc-shaped slideway (813) is fixedly connected to an outer side of the traction rear arm (2), and a prompting column (814) is fixedly connected to a position above a rear side of the traction rear arm (2).

6. The vehicle tractor according to claim 5, wherein the transmission shafts (809) penetrate through a positioning plate (810), a lower end of the positioning plate (810) is fixedly connected to an upper surface of the traction rear arm (2), a reset torsion spring (811) is arranged on an outer side of the positioning plate (810), and the reset torsion spring (811) is sleeved outside the transmission shafts (809).

7. The vehicle tractor according to claim 1, wherein a triangular reinforcement plate (13) is fixedly connected to a connecting position of the traction front arm (1) and the upright column (3).

8. The vehicle tractor according to claim 1, wherein a plurality of front arm pin holes (9) are symmetrically formed in left and right sides of the traction front arm (1), a plurality of rear arm pin holes (11) are symmetrically formed in two sides of the traction rear arm (2), a traction ball (5) is fixedly connected to an upper surface of the traction rear arm (2), and a hook (6) is fixedly connected to a lower surface of the traction rear arm (2).

9. The vehicle tractor according to claim 1, wherein a plurality of upright column pin holes (10) are symmetrically formed in two sides of the upright column (3), and a plurality of gasket pin holes (12) are symmetrically formed in two sides of the concave gasket (4).

10. The vehicle tractor according to claim 4, wherein a connecting spring (805) is sleeved outside each damping telescopic rod (804).
